(19) United States
(12) Patent Application Publication
(10) Pub. No.: US 2021/0324922 A1
(43) Pub. Date: Oct. 21, 2021

(54) Actuating Mechanism, Clutch Actuator and Transmission Actuator With Improved Vibration Behavior

(71) Applicant: KNORR-BREMSE Systeme fuer Nutzfahrzeuge GmbH, Muenchen (DE)

(72) Inventors: Sebastian SCHALLER, Langweid (DE); Juergen SCHUDY, Muenchen (DE)

(21) Appl. No.: 17/288,048

(22) PCT Filed: Sep. 30, 2019
(86) PCT No.: PCT/EP2019/076367

§ 371 Date: Apr. 23, 2021

(30) Foreign Application Priority Data
Oct. 24, 2018 (DE) 10 2018 126 475.5

(51) Int. Cl. F16D 28/00; F16H 25/22

(52) U.S. Cl. CPC F16D 28/00; F16D 2125/40; F16H 25/2209

(57) ABSTRACT

An actuating mechanism includes a transmission element configured to be displaced parallel to a transmission direction, an actuating element configured to perform an actuating movement to cause the displacement of the transmission element in the transmission direction, a conversion mechanism arranged between the transmission element and the actuating element which converts the actuating movement of the actuating element into the displacement of the transmission element, and a bracing element configured to introduce a pretension, preferably an elastic pretension, at least into the conversion mechanism. The invention also relates to a clutch actuator and a transmission actuator having an actuating mechanism in accordance with the present invention.

### BACKGROUND AND SUMMARY OF THE INVENTION

The present invention relates to an actuating mechanism, to a clutch actuator and to a transmission actuator with improved vibration behavior.

Actuating mechanisms which are configured to convert an actuating movement of an actuating element into a displacement of a transmission element have, for said conversion, mechanisms which are subject to backlash, in particular, in the load-free state when the actuating element is not carrying out an actuating movement. A mechanism of this type is configured, for example, as a ball screw drive or as a toothing system. If an actuating mechanism of this type is situated in a vehicle, in particular in a clutch actuator or transmission actuator of the vehicle, said actuating mechanism is loaded greatly by way of the vibrations which occur and are caused, in particular, by way of the engine of the vehicle or, in the case of a clutch actuator, by way of wobbling of the clutch.

Therefore, it is the object of the present invention to provide an actuating mechanism, a clutch actuator and a transmission actuator which have improved vibration behavior.

According to the invention, an actuating mechanism is provided, having:
a transmission element which is configured for a displacement parallel to a transmission direction,
an actuating element which is configured to carry out an actuating movement, in order to cause the displacement of the transmission element,

a conversion mechanism being provided between the transmission element and the actuating element, which conversion mechanism is configured to convert the actuating movement of the actuating element into the displacement of the transmission element, and
a bracing element which is configured to introduce a prestress at least into the conversion mechanism.

The prestress is preferably configured as an elastic prestress.

A force or a torque, namely the prestress, can preferably be introduced into the conversion mechanism by way of the bracing element. Furthermore, the actuating mechanism is preferably configured such that the elements of the conversion mechanism are braced with respect to one another by way of the prestress. The bracing takes place, in particular, in the load-free state, that is to say when no actuating movement is being carried out by way of the actuating element, and therefore when the transmission element is not being displaced.

Accordingly, the prestress introduces a base loading, in particular, into the conversion mechanism, with the result that a backlash which might result in the load-free state does not occur herein, since all the elements are in contact with one another or are held in contact with one another by way of the prestress.

The contact which is produced by way of the prestress is preferably configured in such a way that an incipient actuating movement of the actuating element is carried out directly as a displacement of the transmission element, preferably in the transmission direction.

The actuating mechanism is preferably configured to assist the prestress between the transmission element and the actuating element.

The bracing element is preferably configured to impart the prestress to the transmission element. This preferably takes place in the form of a force in the direction of the transmission direction.

The bracing element is preferably configured, in particular, as a spring or rubber element. As a result, a precise prestress which is produced by way of the bracing element can advantageously be determined by way of knowledge of the material behavior or the spring constant.

The bracing element is preferably supported in a housing of the actuating mechanism directly or via intermediate elements. As an alternative, the bracing element is supported on elements of the actuating mechanism.

As an alternative or in addition, the bracing element is in contact with the transmission element or the actuating element directly or via intermediate elements.

The conversion mechanism is preferably configured to convert a rotational movement, in particular a rotational movement of the actuating element, into the displacement of the transmission element parallel to the transmission direction.

If a force in the transmission direction is applied by way of the bracing element to a conversion mechanism which is configured in this way, a torque is formed in the latter, which torque has to be supported on further elements. In this way, bracing of the conversion mechanism can be achieved by way of a force being imparted to the transmission element.

The conversion mechanism preferably has, in particular, a toothing system, a ball screw drive, a transmission thread, a spindle drive, or a worm thread. They are further preferably configured to convert the actuating movement of the actuating element into a displacement of the transmission element in the transmission direction.

The actuating mechanism preferably has a drive apparatus which is configured to move the actuating element in order to carry out the actuating movement. The drive apparatus is configured, in particular, as an electric motor or a pneumatic or hydraulic actuator. As a result, the actuating mechanism is automated, which is advantageous, in particular, in a clutch actuator or transmission actuator which is used in a utility vehicle. Furthermore, the drive apparatus is preferably in contact with the actuating element, in order to allow the latter to carry out the actuating movement. At least one intermediate element is particularly preferably provided between the drive apparatus and the actuating element, in order to convert a drive movement of the drive apparatus into an actuating movement. An intermediate element of this type has, in particular, a transmission.

In one advantageous embodiment, the drive apparatus is configured as the bracing element. In the load-free state, the drive apparatus introduces the prestress, that is to say a force or torque, at least into the conversion mechanism here, as a result of which the elements of the conversion mechanism overcome their backlash correspondingly and likewise pass into contact as if the actuating element were carrying out an actuating movement. Said embodiment has the advantage that an additional bracing element can be dispensed with.

The actuating mechanism is preferably configured to support the prestress, in particular, by way of a holding force, a holding torque or a locking action.

The support particularly preferably takes place against the drive apparatus which, furthermore, is preferably configured to be locked in the load-free state or to at least apply a holding torque or a holding force against the prestress. If the drive apparatus has an electric motor, the support preferably takes place against the reluctance torque of the electric motor.

The actuating mechanism preferably has a transmission which is configured to convert a drive movement into the actuating movement of the actuating element.

Here, the drive movement is preferably brought about by way of the drive apparatus which is further preferably connected to the transmission. Thus, the transmission can advantageously provide the possibility of providing a drive apparatus which has to introduce merely a relatively low force or a relatively low torque into the transmission.

The transmission preferably has, in particular, a gearwheel mechanism, a worm gear mechanism or a belt mechanism.

As an alternative or in addition, the transmission is configured such that the prestress which is introduced by way of the bracing element is also imparted to the transmission. As a result, bracing of the transmission is advantageously achieved, as a result of which the backlash which can exist, in particular, in the load-free state is also overcome here.

Furthermore, the actuating mechanism preferably has an anti-rotation safeguard which is configured to block a rotational movement of the transmission element about the transmission direction. This ensures that, in the case of an actuating movement of the actuating element, the transmission element does not carry out a rotation about the transmission direction. Instead, the actuating movement is implemented entirely in the transmission direction.

The actuating movement of the actuating element is preferably a rotational movement, particularly preferably about the transmission direction.

The transmission element is preferably configured to release a clutch by means of the displacement in the transmission direction. As an alternative, the transmission element is configured to engage or release a gear of a transmission. To this end, the transmission element is preferably configured to move a corresponding shifting element of a transmission. As an alternative, the transmission element is configured to select a gate of a transmission. This is preferably to be understood to mean that a corresponding shifting element is oriented within the transmission by way of the transmission element in such a way that it can engage or release a gear. To this end, the transmission element is preferably configured to move a corresponding shifting element of a transmission, in order to bring it into engagement with the corresponding gate. The actuating mechanism can be configured for specific applications in automotive or drive technology by way of this configuration of the actuating mechanism and, in particular, of the transmission element. The actuating mechanism can thus preferably be provided in a clutch actuator or in a transmission actuator.

According to the invention, furthermore, a clutch actuator is provided which has an actuating mechanism, as described above. The clutch actuator is preferably configured to actuate, in particular to release, a clutch by way of said actuating mechanism.

According to the invention, furthermore, a transmission actuator is provided which has an actuating mechanism, as described above. By way of the actuating mechanism, the transmission actuator is preferably configured to engage or to release gears in a transmission or to carry out a gate selection.

The above-described embodiments and features can be combined in any desired way with one another, all of the subjects which can be configured as a result being subjects according to the invention.

In the following text, preferred embodiments of the invention are described by means of the appended drawings.

### BRIEF DESCRIPTION OF THE DRAWINGS

FIG. 1 shows one embodiment of an actuating mechanism according to the invention,

FIG. 2 shows a second embodiment of an actuating mechanism according to the invention, and

FIG. 3 shows a third embodiment of an actuating mechanism according to the invention.

### DETAILED DESCRIPTION OF THE DRAWINGS

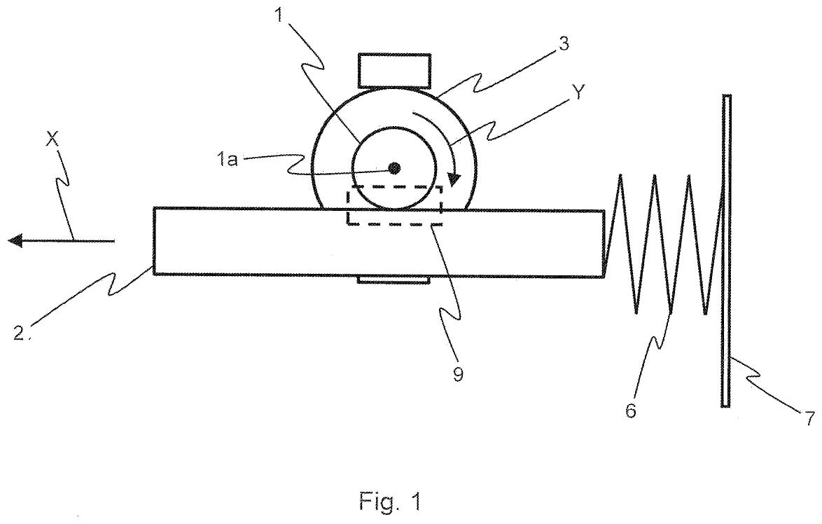

FIG. 1 shows one embodiment of an actuating mechanism according to the invention.

A transmission element 2 is shown which extends in the form of a rod from left to right. The transmission element 2 is configured to be displaced parallel to a transmission direction X. The transmission element 2 has a toothing system (not shown) on its upper side. It is therefore configured as a toothed rack. The transmission element 2 is configured to actuate or to release a clutch (not shown) by way of its left-hand end, by passing into contact with the clutch in the transmission direction X and releasing said clutch by means of displacement in the transmission direction X.

Furthermore, an actuating element 1 is shown which is configured as a pinion. The actuating element 1 is configured such that it can be rotated about a rotational axis 1a which is oriented perpendicularly with respect to the plane of the drawing. The toothing system (not shown) of the pinion is in engagement with the toothing system of the transmission element 2. Here, the two toothing systems form a conversion mechanism 9 which is marked by way of a dashed frame in the region of the engagement of the two toothing systems. The conversion mechanism 9 is configured to convert an actuating movement Y of the actuating element 1 (here, a rotation of the pinion about the rotational axis 1a) into a displacement of the transmission element 2 parallel to the transmission direction X.

The actuating element 1 is connected to a shaft (not shown) of a drive apparatus 3, for example of an electric motor, as a result of which the actuating element 1 can be set in rotation about the rotational axis 1a, as a result of which the performance of the actuating movement Y by way of the actuating element 1 is made possible.

As has been mentioned above, the actuating mechanism which is shown is configured for actuating a clutch by means of the left-hand end of the transmission element 2. In order to actuate the clutch, the actuating element 1 is set in the actuating movement Y by means of the drive apparatus 3. Here, the actuating movement Y of the actuating element 1 is converted by way of the conversion mechanism 9 into a displacement of the transmission element 2 in the transmission direction X. Here, the left-hand end of the transmission element 2 comes into contact with the clutch and releases the latter during the displacement in the transmission direction X.

If the clutch is engaged and the actuating mechanism is in the load-free state, the left-hand end of the transmission element 2 therefore not pressing strongly enough on the clutch to release the latter, vibrations from the clutch from the entire drive train can in turn be transmitted via the contact between the left-hand end of the transmission element 2 and the clutch into the actuating mechanism.

In particular, the conversion mechanism 9 which is configured here as a toothing system between the actuating element 1 and the transmission element 2 can be subject to backlash, furthermore. Vibrations which are transmitted to the transmission element 2 would, on account of the backlash, bring about a relative movement of the toothing system of the conversion mechanism 9 among one another, as a result of which individual teeth of the toothing system would strike one another and be subject to wear.

Therefore, furthermore, a bracing element 6 adjoins on the right of the transmission element 2, which bracing element 6 is configured as a spring which is supported on the right in a housing 7 of the actuating mechanism. The bracing element 6 is configured to apply a prestress in the form of a force parallel to the transmission direction X to the right-hand end of the transmission element 2, with which it is directly in contact.

Said prestress acts in such a way that at least part thereof is supported in the conversion mechanism 9, specifically in the toothing system. Via the toothing system of the conversion mechanism 9, the prestress is transmitted further to the drive apparatus 3 which is configured to counteract the prestress. If the drive apparatus 3 is configured as an electric motor, this torque can be applied as a reluctance torque.

As a result, a prestress with a defined magnitude is constantly introduced into the conversion mechanism 9, which prestress is configured in such a way that the backlash within the toothing system is overcome. The actuating element 1 and the transmission element 2 are therefore in contact even in the load-free state as a result of the prestress. The conversion mechanism 9 is therefore of backlash-free configuration.

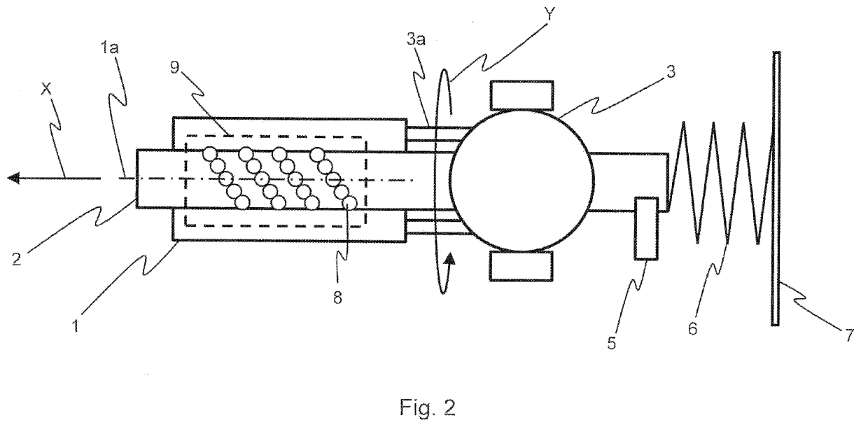

FIG. 2 shows a second embodiment of an actuating mechanism according to the invention.

A transmission element 2 is shown which extends in the form of a rod from left to right. The transmission element 2 is configured to be displaced parallel to a transmission direction X. The transmission element 2 is configured to actuate or to release a clutch (not shown) by way of its left-hand end, by passing into contact with the clutch in the transmission direction X and releasing said clutch.

Furthermore, an actuating element 1 is shown which is configured as a nut. Here, the actuating element 1 is configured such that it can be rotated in an actuating direction Y about a rotational axis 1a which is oriented parallel to the transmission direction X. The actuating element 1 is connected via a drive element 3a which is configured here as a hollow shaft to a drive apparatus 3, for example to an electric motor, as a result of which the actuating element 1 can be rotated about the rotational axis 1a. The drive element 3a is configured to apply a drive movement to the actuating element 1. The drive apparatus 3 is configured to apply the drive movement to the drive element 3a.

The transmission element 2 and the actuating element 1 are oriented coaxially with respect to one another, the transmission element 2 penetrating the actuating element 1. Furthermore, the transmission element 2 to the right of the actuating element 1 also penetrates the drive element 3a and the drive apparatus 3 which are oriented coaxially with respect to the transmission element 2.

A ball screw drive with circulating balls 8 is provided between the actuating element 1 and the transmission element 2. Here, the balls 8 are guided in ball guides (not shown) which are situated on the outer side of the transmission element 2 and on the inner side of the actuating element 1. Here, the ball screw drive is a conversion mechanism 9. The conversion mechanism 9 is marked by way of a dashed frame.

The actuating movement Y of the actuating element 1 can be transmitted by way of the conversion mechanism 9 to the transmission element 2 which thereupon experiences a displacement in the transmission direction X.

Furthermore, an anti-rotation safeguard 5 is provided at the right-hand end of the transmission element 2. Said anti-rotation safeguard 5 is configured to block a rotational movement of the transmission element 2 about the transmission direction X or about the rotational axis 1a in a positively locking manner, with the result that the actuating movement Y is converted completely into a displacement in the transmission direction X.

As has been mentioned above, the actuating mechanism which is shown is configured for actuating a clutch by means of the left-hand end of the transmission element 2. In order to actuate the clutch, the actuating element 1 is set in the actuating movement Y by means of the drive apparatus 3. Here, the actuating movement Y of the actuating element 1 is converted by way of the conversion mechanism 9 into a displacement of the transmission element 2 in the transmission direction X. Here, the left-hand end of the transmission element 2 comes into contact with the clutch and releases the latter during the displacement in the transmission direction X.

If the clutch is engaged and the actuating mechanism is in the load-free state, the left-hand end of the transmission element 2 therefore not pressing strongly enough on the clutch to release the latter, vibrations from the clutch or from the entire drive train can in turn be transmitted via the contact between the left-hand end of the transmission element 2 and the clutch into the actuating mechanism.

In particular, the conversion mechanism 9 which is configured here as a ball screw drive between the actuating element 1 and the transmission element 2 can be subject to backlash. Vibrations which are transmitted to the transmission element 2 would bring about a relative movement of the balls 8 and/or the ball guides on account of the backlash, as a result of which individual balls 8 would strike one another and be subject to wear or as a result of which the ball guides would be subject to wear.

Therefore, a bracing element 6 adjoins, furthermore, to the right of the transmission element 2, which bracing element 6 is configured as a spring in an analogous manner with respect to the bracing element 6 from FIG. 1, which spring is supported on the right in a housing 7 of the actuating mechanism. Said bracing element 6 is also configured to apply a prestress in the form of a force parallel to the transmission direction X to the right-hand end of the transmission element 2, with which it is directly in contact.

Said prestress acts in such a way that at least part thereof is supported in the conversion mechanism 9, specifically in the ball screw drive. Furthermore, said support brings it about in the conversion mechanism 9 that a torque is built up between the transmission element 2 and the actuating element 1. The prestress is transmitted further via the ball screw drive of the conversion mechanism 9 and the drive element 3a to the drive apparatus 3 which is configured to generate a torque which counteracts the prestress. If the drive apparatus 3 is configured as an electric motor, said torque can be applied as a reluctance torque.

As a result, a prestress with a defined magnitude is constantly introduced into the conversion mechanism 9, which prestress is configured in such a way that the backlash within the ball screw drive is overcome. The actuating element 1 and the transmission element 2 are therefore in contact even in the load-free state as a result of the prestress. The conversion mechanism 9 is therefore of backlash-free configuration.

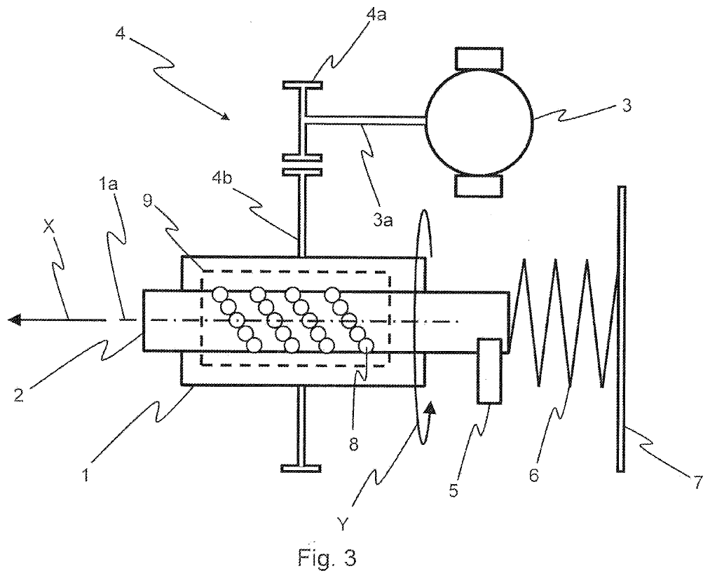

FIG. 3 shows a third embodiment of an actuating mechanism according to the invention.

Said embodiment is substantially an enhancement of the actuating mechanism from FIG. 2.

A transmission element 2 is shown which extends in the form of a rod from left to right. The transmission element 2 is configured to be displaced parallel to a transmission direction X. The transmission element 2 is configured to actuate, or to release, a clutch (not shown) by way of its left-hand end, by passing into contact with the clutch in the transmission direction X and releasing said clutch.

Furthermore, an actuating element 1 is shown which is configured as a nut. Here, the actuating element 1 is configured such that it can be rotated in an actuating direction Y about a rotational axis 1a which is oriented parallel to the transmission direction X. The actuating element 1 is connected via a transmission 4, which is configured as a gearwheel mechanism with a first gearwheel 4a and a second gearwheel 4b, and a drive element 3a, which is configured here as an input shaft of the transmission 4, to a drive apparatus 3, for example to an electric motor, as a result of which the actuating element 1 can be rotated about the rotational axis 1a. The drive element 3a is configured to introduce a drive movement into the transmission 4 and therefore to transmit it to the actuating element 1. The drive apparatus 3 is configured to apply the drive movement to the drive element 3a.

The transmission element 2 and the actuating element 1 are configured coaxially with respect to one another, the transmission element 2 penetrating the actuating element 1. The drive element 3a and the drive apparatus 3 are arranged offset with respect to the transmission direction X.

A ball screw drive with circulating balls 8 is provided between the actuating element 1 and the transmission element 2. Here, the balls 8 are guided in ball guides (not shown) which are situated on the outer side of the transmission element 2 and on the inner side of the actuating element 1. Here, the ball screw drive is a conversion mechanism 9. The conversion mechanism 9 is marked by way of a dashed frame.

Furthermore, the transmission element 2 is in contact with an anti-rotation safeguard 5 which is of substantially comparable configuration with respect to the anti-rotation safeguard 5 from FIG. 2, in order to ensure a complete conversion of the actuating movement Y into the displacement in the transmission direction X.

As has been mentioned above, the actuating mechanism which is shown is configured to actuate a clutch by means of the left-hand end of the transmission element 2. In order to actuate the clutch, the actuating element 1 is set in the actuating movement Y by means of the drive apparatus 3 via the drive element 3a and the transmission 4. Here, the actuating movement Y of the actuating element 1 is converted by way of the conversion mechanism 9 into a displacement of the transmission element 2 in the transmission direction X. Here, the left-hand end of the transmission element 2 comes into contact with the clutch and releases the latter during the displacement in the transmission direction X.

If the clutch is engaged and the actuating mechanism is in the load-free state, the left-hand end of the transmission element 2 therefore not pressing strongly enough on the clutch, in order to release the latter, vibrations can in turn be transmitted from the clutch or from the entire drive train via the contact between the left-hand end of the transmission element 2 and the clutch into the actuating mechanism.

In particular, the conversion mechanism 9 which is configured here as a ball screw drive between the actuating element 1 and the transmission element 2, can, furthermore, be subject to backlash. Moreover, backlash can also occur between the first gearwheel 4a and the second gearwheel 4b of the transmission 4. Vibrations which are transmitted to the transmission element 2 would bring about a relative movement of the balls 8 and/or the ball guides in the actuating element 1 and the transmission element 2 of the conversion mechanism 9 with respect to one another on account of the backlash, as a result of which individual balls 8 would strike one another and would be subject to wear or the ball guides would be subject to wear. Furthermore, a relative movement can also occur in the toothing system between the first gearwheel 4a and the second gearwheel 4b, as a result of which individual teeth can strike one another here and therefore would be subject to wear.

In this exemplary embodiment, therefore, a plurality of transition points of the actuating mechanism are potentially subject to wear.

Therefore, a bracing element 6 adjoins, furthermore, to the right of the transmission element 2, which bracing element 6 is configured, in an analogous manner with respect to the bracing elements 6 from FIG. 1 and FIG. 2, as a spring which is supported on the right in a housing 7 of the actuating mechanism. Said bracing element 6 is also configured to apply a prestress in the form of a force parallel to the transmission direction X to the right-hand end of the transmission element 2, with which it is directly in contact.

Said prestress acts in such a way that at least part thereof is supported in the conversion mechanism 9, specifically in the ball screw drive. A torque is applied to the actuating element 1 via the ball screw drive of the conversion mechanism 9, which torque is transmitted further to the drive apparatus 3 via the transmission 4 and the drive element 3a. The drive apparatus 3 is configured to generate a torque which counteracts said torque and therefore the prestress. If the drive apparatus 3 is configured as an electric motor, said torque can be applied as a reluctance torque.

As a result, a prestress with a defined magnitude is constantly introduced into the conversion mechanism 9, which prestress is configured in such a way that the backlash within the ball screw drive and/or the thread 4 is overcome. The actuating element 1 and the transmission element 2 are therefore in contact as a result of the prestress even in the load-free state. Therefore, the conversion mechanism 9 is of backlash-free configuration.

The exemplary embodiments which are shown do not have a restrictive effect on the subject matter of the invention. Rather, further embodiments can be obtained by way of variation, combination, replacement or omission of individual features, which further embodiments can likewise be considered to be objects according to the invention.

Thus, for example, the anti-rotation safeguard 5 is to be considered merely optional.

Furthermore, in the case of a configuration of the actuating element 1 as a nut and the transmission element 2 as a rod, the conversion mechanism 9 can also be configured as a spindle drive, transmission thread or as another suitable embodiment.

The transmission 4 also does not necessarily have to be configured as a transmission with a first gearwheel 4a and a second gearwheel 4b. Instead, the transmission 4 can also, as an alternative or in addition, have a worm drive, a belt drive or another suitable transmission embodiment, and more than only one transmission stage.

In addition, the transmission does not necessarily have to be provided in the case of embodiments, in the case of which the actuating element is configured as a nut. The embodiment from FIG. 1 and further embodiments can also have a transmission 4 between the actuating element 1 and the transmission element 2.

Furthermore, the bracing element 6 is not necessarily to be configured as a spring which has a translational action. Moreover, for example, the configuration as a torsion spring with a corresponding attachment is possible. It is also not absolutely necessary that the bracing element 6 is configured to apply the prestress to the transmission element 2. As an alternative or in addition, the prestress can also be applied to the actuating element 1 or another element, for example one of the gearwheels 4a, 4b.

The bracing element can also apply the prestress not in a direct manner, but rather via intermediate elements, in particular, to the actuating element 1 or to the transmission element 2.

Furthermore, the drive apparatus 3 does not necessarily have to be configured as an electric motor. Instead, a hydraulic or pneumatic drive apparatus can also be provided here.

Furthermore, the actuating movement Y is not necessarily to be configured as a rotational movement about a rotational axis 1a. The actuating mechanism, in particular the conversion mechanism 9 and/or the transmission 4, can be configured in such a way that a translational actuating movement Y or an actuating movement Y with at least a translational component is also converted into a displacement of the transmission element 2 in the transmission direction X.

Finally, a torque of the drive device does not necessarily have to be used in order to support the prestress. Instead, a locking means can also be provided in the embodiments which are shown and further embodiments, which locking means is configured to lock in the load-free state, as a result of which supporting of the prestress against the locking means takes place. The locking means can be provided, in particular, in the drive apparatus 3, the transmission 4 or other elements which are configured to convert the drive movement or the actuating movement Y into the displacement of the transmission element 2 along the transmission direction.

The embodiments which are shown in FIGS. 1, 2 and 3 relate to actuating mechanisms for releasing a clutch, it being possible for the actuating mechanisms to be provided in a clutch actuator. Moreover, further embodiments are conceivable, in the case of which the transmission element 2 is configured to actuate an element in a transmission. Said element is configured, for example, to engage or to release a gear or to carry out a gate selection. Therefore, the actuating mechanism can also be provided in a transmission actuator, a transmission actuator of this type also having improved vibration behavior as a result of the actuating mechanism.

### LIST OF DESIGNATIONS

1 Actuating element
1a Rotational axis
2 Transmission element
3 Drive apparatus
3a Drive element
4 Transmission
4a First gearwheel
4b Second gearwheel
5 Anti-rotation safeguard
6 Bracing element
7 Housing
8 Ball
9 Conversion mechanism
X Transmission direction
Y Actuating movement

1-13. (canceled)

14. An actuating mechanism, comprising:
a transmission element configured to be displaced parallel to a transmission direction;
an actuating element configured to displace the transmission element in the transmission direction in response to an actuating movement of the actuating element;
a conversion mechanism between the transmission element and the actuating element, the conversion mechanism being configured to convert the actuating movement of the actuating element into displacement of the transmission element in the transmission direction; and
a bracing element configured to introduce a prestress at least into the conversion mechanism such that backlash in the actuating mechanism is reduced.

15. The actuating mechanism as claimed in claim 14, wherein
the bracing element is configured to apply the prestress to the transmission element.

16. The actuating mechanism as claimed in claim 15, wherein
the bracing element is at least one of
a spring or an elastic rubber element,
in a housing or on elements of the actuating mechanism, and
in contact with at least one of the transmission element or the actuating element, the contact being at least one of directly and via intermediate elements.

17. The actuating mechanism as claimed in claim 16, wherein
the conversion mechanism is configured to convert a rotational movement of the actuating element into the displacement of the transmission element in the transmission direction.

18. The actuating mechanism as claimed in claim 17, wherein
the conversion mechanism includes a toothing system, a ball screw drive, a transmission thread, a spindle drive, or a worm thread.

19. The actuating mechanism as claimed in claim 17, wherein
the actuating mechanism is configured to support the prestress using one or more of a holding force, a holding torque or a locking action.

20. The actuating mechanism as claimed in claim 17, further comprising:
a drive apparatus configured to drive the actuating movement of the actuating element.

21. The actuating mechanism as claimed in claim 20, further comprising:
a transmission configured to convert a drive movement of the drive apparatus into the actuating movement of the actuating element.

22. The actuating mechanism as claimed in claim 21, wherein
the transmission at least one of
includes a one or more of a gearwheel mechanism, a worm gear mechanism or a belt mechanism, and
is configured such that the prestress which is introduced by the bracing element is also applied to the transmission.

23. The actuating mechanism as claimed in claim 17, further comprising:
an anti-rotation safeguard configured to block a rotational movement of the transmission element about the transmission direction.

24. The actuating mechanism as claimed in claim 17, wherein
the transmission element is configured to release a clutch or to engage or release a gear of a transmission or to select a gate of a transmission when the transmission element is displaced in the transmission direction.

25. A clutch actuator, comprising:
an actuating mechanism configured to actuate a clutch, the actuator mechanism having
a transmission element configured to be displaced parallel to a transmission direction;
an actuating element configured to displace the transmission element in the transmission direction in response to an actuating movement of the actuating element;
a conversion mechanism between the transmission element and the actuating element, the conversion mechanism being configured to convert the actuating movement of the actuating element into displacement of the transmission element in the transmission direction; and
a bracing element configured to introduce a prestress at least into the conversion mechanism such that backlash in the actuating mechanism is reduced.

26. A transmission actuator, comprising:
an actuating mechanism configured to actuate a transmission, the actuator mechanism having
a transmission element configured to be displaced parallel to a transmission direction;
an actuating element configured to displace the transmission element in the transmission direction in response to an actuating movement of the actuating element;
a conversion mechanism between the transmission element and the actuating element, the conversion mechanism being configured to convert the actuating movement of the actuating element into displacement of the transmission element in the transmission direction; and
a bracing element configured to introduce a prestress at least into the conversion mechanism such that backlash in the actuating mechanism is reduced.
